(19) United States
(12) Patent Application Publication
(10) Pub. No.: US 2009/0207812 A1
(43) Pub. Date: Aug. 20, 2009

(54) DUAL RADIO HANDOVERS BEWEEN WIMAX AND 3GPP

(76) Inventors: Vivek Gupta, Milpitas, CA (US); Pouya Taaghol, San Jose, CA (US); Puneet Jain, Hillsboro, CA (US)

Correspondence Address: INTEL CORPORATION;c/o CPA Global, P.O. BOX 52050, MINNEAPOLIS, MN, 55402, US

(21) Appl. No.: 12/347,880

(22) Filed: Dec. 31, 2008

Related U.S. Application Data
(60) Provisional application No. 61/019,539, filed on Jan. 7, 2008.

(51) Int. Cl. H04W 36/00; H04W 36/24; H04W 36/34

(52) U.S. Cl. 370/332; 455/436; 370/338

(57) ABSTRACT

A method of switching a device from a source network to a target network, the source network being one of a WiMAX network and a 3GPP network and the target network being another of the WiMAX network and the 3GPP network, may include receiving information from the device about the source network and about the target network. The information received from the device may be monitored to determine whether parameters of the source network have crossed a handoff threshold. The information received from the device also may be monitored to determine whether parameters of the target network are suitable for handoff. The method may also include instructing the device to perform a handover of communications to a radio associated with the target network based on the parameters of the source network, the parameters of the target network, and a handoff policy.

### CROSS-REFERENCE TO RELATED APPLICATIONS

The present application claims the benefit of U.S. provisional application Ser. No. 61/019,539, filed Jan. 7, 2008, (docket # P26930Z) entitled “Dual Radio Handovers Between WiMAX and 3GPP,” the entire content of which is incorporated by reference herein.

### BACKGROUND

Implementations of the claimed invention generally may relate to wireless communication, and in particular to handovers between different wireless networks.

Mobile service providers already possess and operate several heterogeneous access technologies and networks. Mixed network environments are expected to become more common as different radio technologies best serve different deployment types and usages. For example, WiFi (IEEE 802.11a/b/g/n) has shown to be a great technology for indoor operation whereas cellular technologies such as 3GPP 2G/3G and WiMAX operate best in licensed spectrum covering large outdoor areas. It is also expected that multi-mode and/or multi-radio wireless devices will become widespread. Hence, it is of interest to the mobile operators, technology users, and vendors to provide seamless mobility between these heterogeneous access technologies with uninterrupted service continuity.

So far, proposed approaches have focused on pure layer 3 mobility solutions such as Mobile IP. Though, these technologies support an inter-access mobility answer, the handoff delay could be extremely high. Furthermore, such L3 mobility procedures rely completely on the mobile device to make a handoff decision.

Hence, different approaches to inter-network handovers may be desirable.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 shows an architecture for optimized dual radio handover between WiMAX and 3GPP networks;

FIG. 2 shows a protocol stack for signaling between 3GPP and WiMAX networks;

FIG. 3 shows measurement control procedures;

FIG. 4 shows a detailed handover flow for handovers from 3GPP to WiMAX; and

FIG. 5 shows a detailed handover from WiMAX to 3GPP.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

This application discloses an alternative architecture and a dual radio network controlled handover solution based on operator policy and radio resource management (RRM), and describes how to achieve overall lower latency of handovers and packet loss.

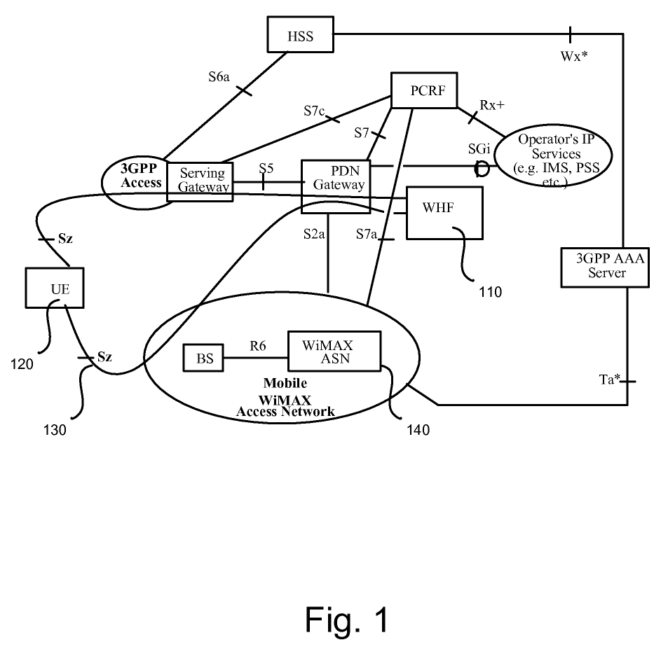

FIG. 1 illustrates an exemplary architecture for network controlled handovers between mobile WiMAX and 3GPP accesses (e.g., GERAN, UTRAN, and E-UTRAN). A logical functional entity called WiMAX handover function (WHF) 110 is used in the 3GPP non-access stratum (NAS). The WHF 110 makes handover decisions and controls the overall handover operation from the network side. The WHF 110 monitors active radio operation and receives regular measurement reports and other link layer information on the active radio (WiMAX or 3GPP) from the user equipment (UE) 120 over IP-based Sz reference point.

For example the WHF 110 may monitor the receive signal strength indicator (RSSI), carrier to interference noise ratio (CINR), signal quality, and/or Rx power strength parameters. When link layer parameters on the active radio degrade and cross the pre-specified threshold the WHF 110 may search for other candidate networks. The WHF 110 may cause the UE 120 to power on the target radio and scan for available networks. On further degradation of link layer parameters on the active radio and based on specified cell reselection criteria, the WHF 110 may initiate a handover to selected target radio. The handover decision process may involve parameters other than radio measurements such as operator policy.

Based on radio measurement reports and operator's policy the WHF 110 may instruct the UE 120 to prepare for active handover to the target network. In case of dual-radio operation, the resource reservation, authentication and other aspects of target system preparation are triggered by the UE 120 directly on the target radio. Once all target preparation has been completed the WHF 110 sends a handover command to the UE 120 to switch to target network. The WHF 110 may then send a command to UE 120 to release resources on source network after the active session has been handed over and normal packet delivery has resumed on the target network.

In the non-roaming case the WHF 110 is located in a home public land mobile network (HPLMN). The address of WHF 110 may be pre-configured on the UE 120 or it may be discovered through a domain name server (DNS) query. In the roaming case the WHF 110 may be located in a visited public land mobile network (VPLMN) or HPLMN and may be discovered through a DNS query. Generic IP layer security as specified by IPSec may be used (TS 33.234) may be used for transport connections between UE 120 and WHF 110.

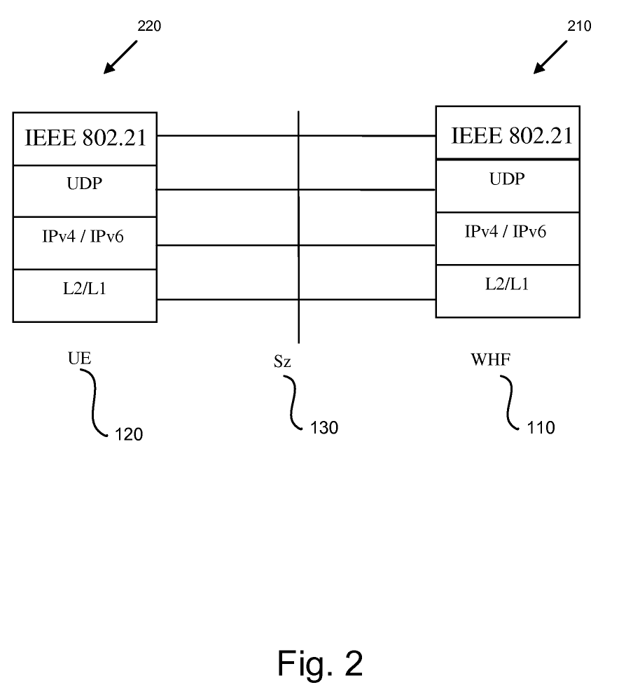

FIG. 2 shows protocol stack(s) 210/220 for signaling between 3GPP and WiMAX networks. The reference point Sz 130 enables interactions between UE and Mobile WiMAX Handover Function (WHF) 110. It supports messages for measurement reports, link layer triggers and handover control between Mobile WiMAX and 3GPP accesses. These messages are transported as opaque containers without modifications by the 3GPP and Mobile WiMAX accesses.

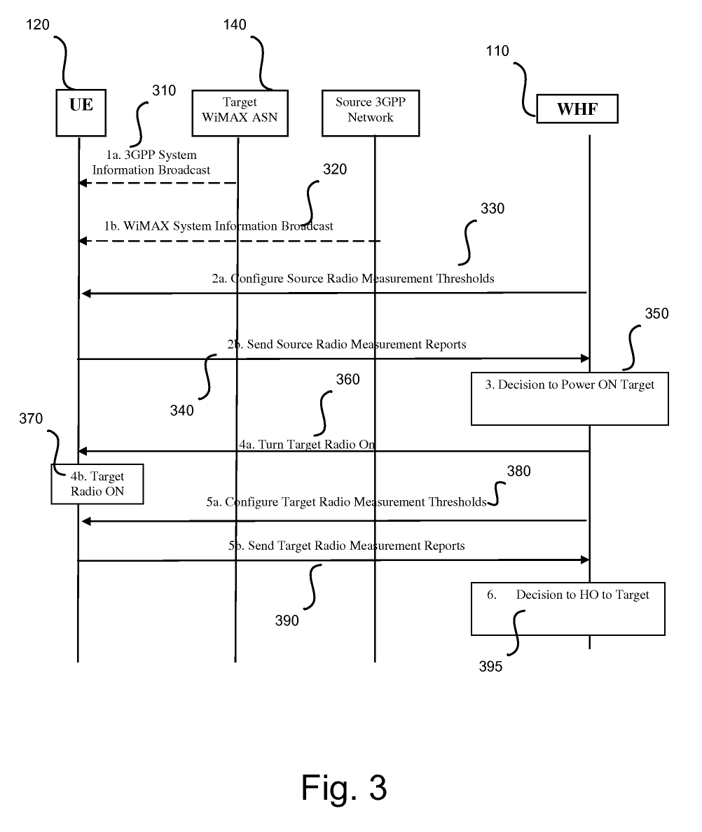

FIG. 3 shows measurement control procedures for network controlled handoff between 3GPP & WiMAX (one of which may be a source network and the other of which may be a target network, depending on which network the UE 120 is currently connected to (i.e., the source)). Processing may begin with the 3GPP network broadcasting information about WiMAX network to UE 120 [act 310]. The can include information such as frequency of WiMAX neighbouring cells, operator identifier, WiMAX profile version, etc. which can help in WiMAX discovery and selection. Similarly the WiMAX radio may broadcast information about 3GPP networks to UE 120 [act 320].

Processing may continue with the WHF 110 monitoring the source radio operation. The WHF 110 may configure thresholds for link layer parameters for the source radio [act 330] and may receive regular measurement reports from the UE 120 [act 340]. The WHF 110 may configure the UE 120 to receive cell-reselection triggers as well in act 340.

When the source radio measurements degrade and cross a certain threshold, the WMF 110 may decide to perform cell-reselection to the target network [act 350]. Implicit in act 350 is a recurring comparison of the measurement(s) with the threshold(s). The WHF 110 may instruct the UE 120 to power on the target radio and to initiate a procedure for network scanning [act 360]. In response to such instruction UE 120 may turn on the target radio (e.g., the radio associated with the target network, be it WiMAX or 3GPP) [act 370]. It should be noted that the radio in UE 120 may not be literally “turned on,” in response to act 360, but rather just brought to a more operational state than previously (e.g., sleep or power saving).

WHF 120 may monitor the Target radio operations as well. The WHF 120 may configure thresholds for link layer parameters for the target radio [act 380] and may also receive measurement reports from the UE 120 [act 390]. Based on a comparison of source and target measurement reports and/or operator policy the WHF 110 may decide to perform a handover of the in-process communication to the target radio, thereby switching UE 120 to the other, target network [act 395].

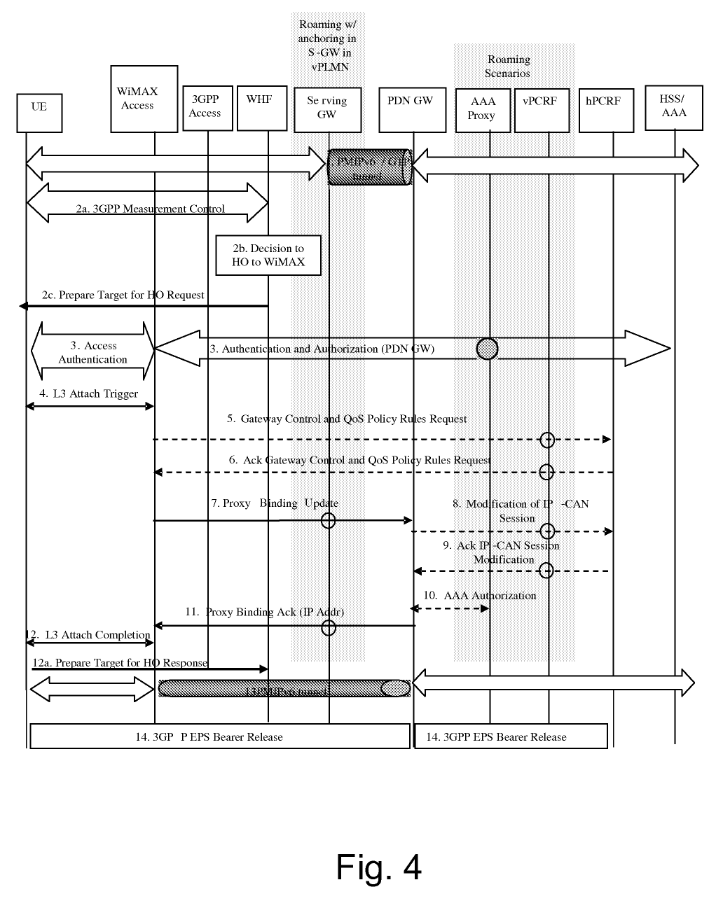

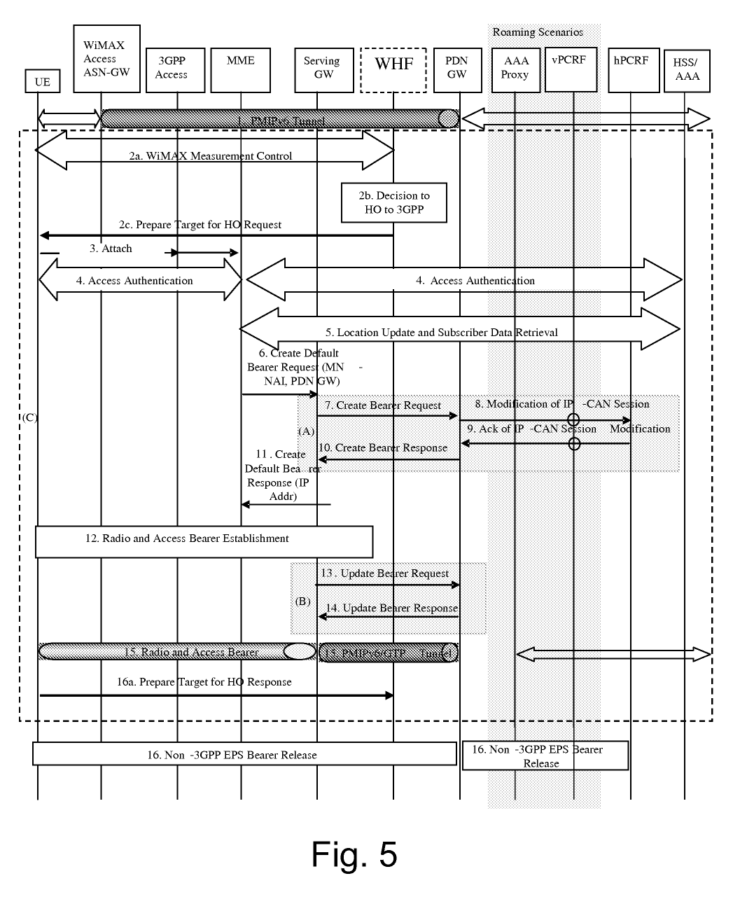

FIG. 4 shows a detailed handover flow for handovers from 3GPP to WiMAX. Although reference numbers 1, 2a, . . . 14 are embedded in FIG. 4, they will be referred to respectively as 401, 402a, . . . 414 herein to differentiate them from a similar range of numbers in FIG. 5, and to indicate that the elements referred to may be found in FIG. 4. Also, although not explicitly labeled as such the various components (e.g., UE, WiMAX Access, etc.) across the top of FIG. 4 may correspond to their respective counterparts in FIG. 1.

In act 401, the UE is connected in the 3GPP Access and has a PMIPv6 or GTP tunnel on the S5 interface. In act 402a, the UE 120 performs measurement control procedures on 3GPP access. Based on cell reselection criteria and operator policy, the WHF 110 may decide to handover to mobile WiMAX [act 402b]. The WHF 110 then sends a message to UE 120 to prepare the target mobile WiMAX radio for handover [act 402c].

In act 403, the UE 120 performs access authentication and authorization in the non-3GPP access system. The 3GPP AAA server authenticates and authorizes the UE 120 for access in the trusted non-3GPP system. The 3GPP AAA server queries the HSS and returns the PDN-GW address to the trusted non-3GPP access system at this step (upon successful authentication and authorization).

In act 404, after successful authentication and authorization, the L3 attach procedure is triggered. In act 405, the entity in the trusted non-3GPP IP Access performing the bearer binding sends an “Gateway Control and QoS Policy Rules Request” message to the PCRF) to obtain the rules required for the gateway in the Trusted non-3GPP IP Access to perform the bearer binding for all the active sessions the UE has established as a result of the L3 Attach procedure in the Trusted non-3GPP IP Access.

In act 406, the PCRF sends to the entity in the Trusted non-3GPP IP Access performing the bearer binding an “Gateway Control and QoS Policy Rules Reply” message including QoS policy rules enabling gateway in the Trusted non-3GPP IP Access to perform the bearer binding. In the case of roaming the “Gateway Control and QoS Policy Rules Reply” message is relayed from PCRF in the HPLMN through the PCRF in the VPLMN to the entity in the Trusted non-3GPP IP Access performing the bearer binding. If the updated PCC rules require establishment of dedicated bearer for the UE, the establishment of those bearers take place before act 407. It is FFS how the establishment of the default and dedicated bearers is synchronized.

In act 407, the entity in the Trusted non-3GPP IP Access acting as a MAG sends a PMIPv6 Proxy Binding Update message. In act 408, the PDN GW requires configuration for enforcing policy, the PDN GW sends an “Modification of IP-CAN session” message to the PCRF. In act 409, the PDN GW has requested an IP CAN session, the PCRF responds to the PDN GW with an “Acknowledge IP-CAN session Modification” message. This message includes the Policy and Charging rules provisioned to the PDN GW.

In act 410, the PDN-GW may interact with the 3GPP AAA server to perform authorization function, e.g., authorization of the new MAG. In act 411, the PDN GW processes the proxy binding update and updates the binding cache entry for the UE. It confirms the IP address(es) for the UE sending a “Proxy Binding Acknowledgement (PBA)” to the MAG function in Trusted Non-3GPP IP Access, including the IP address(es) allocated for the UE.

In act 412, the L3 attach procedure is completed at this point. The IP address(es) assigned to the UE by the PDN-GW is conveyed to the UE. The UE sends a target radio preparation complete response to WHF. In act 413, the PMIPv6 tunnel is set up between the Trusted Non-3GPP IP Access and the PDN GW. The UE can send/receive IP packets at this point. In act 414, the PDN GW triggers the bearer release in the 3GPP Access using the PDN GW initiated Bearer Deactivation procedure. Radio Bearers associated with the PDN address are released if existing.

FIG. 5 shows a detailed handover flow for handovers from WiMAX to 3GPP. Although reference numbers 1, 2a, . . . 16 are embedded in FIG. 5, they will be referred to respectively as 501, 502a, . . . 516 herein to differentiate them from a similar range of numbers in FIG. 4, and to indicate that the elements referred to may be found in FIG. 5. Also, although not explicitly labeled as such the various components (e.g., UE, WiMAX Access, etc.) across the top of FIG. 5 may correspond to their respective counterparts in FIG. 1.

In act 501, the UE 120 uses a Mobile WiMAX access system and is being served by WiMAX ASN GW (as PMIPv6 LMA). In act 502a, the UE 120 performs Measurement Control procedures on Mobile WiMAX access as described above (with regard to FIG. 3). Based on cell reselection criteria and operator policy, the WHF 110 may decide to handover to 3GPP access [act 502b]. The WHF 110 then may send a message to UE 120 to prepare the target 3GPP access for handover [act 502c].

In act 503, the UE 120 sends an attach request to the MME. The message from the UE may be routed by E-UTRAN to the MME as specified in TS 23.401 (E-UTRAN). In act 504, the MME contacts the HSS and authenticates the UE. In act 505, after successful authentication, the MME performs location update procedure and subscriber data retrieval from the HSS as specified in TS 23.401. The PDN GW address may be conveyed to the MME with the subscriber data as described in TS 23.401

In act 506, the MME selects a serving GW as described in TS 23.401 and sends a Create Default Bearer Request (including IMSI, MME Context ID (SGSN equivalent is TBD), and PDN-GW address) message to the selected Serving GW. In act 507, the Serving GW sends a Create Bearer Request message to the PDN-GW in the VPLMN or HPLMN as described in TS 23.401. The PDN GW should not switch the tunnel from non-3GPP IP access to 3GPP access system at this point.

In act 508, the PDN GW sends an “Modification of IP-CAN session” message (IP-CAN Type) to the to obtain the rules required for the PDN GW in the VPLMN or HPLMN to function as the PCEF for all the active sessions the UE has established with the new IP-CAN type as a result of the handover procedure. In act 509, the PCRF sends to the PDN GW an “Acknowledge IP-CAN Session Modification” message (PCC Rules) including QoS policy and charging rules for the new IP-CAN type.

In act 510, the PDN GW responds with a Create Bearer Response message to the Serving GW as described in TS 23.401. The Create Bearer Response contains the IP address or the prefix that was assigned to the UE while it was connected to the non-3GPP IP access. In act 511, the Serving GW returns a Create Default Bearer Response message to the MME as specified in TS 23.401 [4]. This message also includes the IP address of the UE. This message also serves as an indication to the MME/ that the S5 bearer setup and update has been successful. At this step the PMIPv6 or GTP tunnel(s) over S5 is/are established.

In act 512, the Radio and Access bearers are established at this step in the 3GPP access as specified in TS 23.401[4]. In act 513, the Serving GW sends an Update Bearer Request message to the PDN GW including the RAN procedures ready flag that prompts the PDN GW to tunnel packets from non 3GPP IP access to 3GPP access system and immediately start routing packets to the Serving GW for the default and any dedicated EPS bearers established. In act 514, the PDN GW acknowledges by sending Update Bearer Response to the Serving GW.

In act 515, the UE sends and receives data at this point via the E-UTRAN system. In act 516, the PCRF or the PDN GW releases the resources in the Mobile WiMAX access. With a trigger for resource release, a Mobile WiMAX resource release procedure is executed.

The techniques described herein may achieve low latency network controlled handoffs between mobile WiMAX and 3GPP accesses (2G and/or 3G and/or LTE). Other access networks like CDMA also follow a similar approach, and such approach may have lesser impact on the legacy 3G infrastructure. It allows WiMAX as an access to function with the evolving 3GPP core network. Handoffs may be conducted either based on radio conditions (RRM) or based on operator policy.

The IEEE 802.21-based, media independent approach described herein allows such techniques to be easily extended to other networks as well. For example, such may be readily applied to WiMAX Forum NWG network specification, 3GPP SAE (System Architecture Evolution), WiFi system architecture, etc. The overall network-controlled architecture may be extended to single radio operation as well, as will be understood by those skilled in the wireless networking art.

Such techniques described herein may also be incorporated in multi-mode wireless products, such as laptops and/or other handheld/cellular phones and/or PDAs and/or wireless-enabled media devices. Prior to the instant application, the concept of dual radio network controlled handovers has not been specified/introduced for WiMAX systems in standards-related bodies.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A method of switching a device from a source network to a target network, the source network being one of a WiMAX network and a 3GPP network and the target network being another of the WiMAX network and the 3GPP network, comprising:
receiving information from the device about the source network;
monitoring the information received from the device to determine whether parameters of the source network have crossed a handoff threshold; and
instructing the device to turn on a target radio based on the parameters of the source network and the handoff threshold.

2. The method of claim 1, wherein the source network is the WiMAX network and the target network is the 3GPP network.

3. The method of claim 1, wherein the source network is the 3GPP network and the target network is the WiMAX network.

4. The method of claim 1, further comprising:
receiving information from the device about the target network; and
monitoring the information received from the device to determine whether parameters of the target network are suitable for handoff.

5. The method of claim 4, further comprising:
instructing the device to perform a handover of communications to a radio associated with the target network based on the parameters of the target network and a handoff policy.

6. A method of switching from a source network to a target network, the source network being one of a WiMAX network and a 3GPP network and the target network being another of the WiMAX network and the 3GPP network, comprising:
receiving information about the source network;
receiving information about the target network;
receiving source radio measurement thresholds from a control entity;
transmitting source radio measurement reports to the control entity; and
receiving instructions to turn on a target radio based from the control entity.

7. The method of claim 6, wherein the source network is the WiMAX network and the target network is the 3GPP network.

8. The method of claim 6, wherein the source network is the 3GPP network and the target network is the WiMAX network.

9. The method of claim 6, further comprising:
turning on a target radio in response to the instructions; and
initiating network scanning with the target radio.

10. The method of claim 9, further comprising:
receiving target radio measurement thresholds from the control entity;
transmitting target radio measurement reports to the control entity.

11. The method of claim 10, further comprising:
receiving instructions to perform a handover of communications to the target radio associated with the target network.

12. A method of switching a device from a source network to a target network, the source network being one of a WiMAX network and a 3GPP network and the target network being another of the WiMAX network and the 3GPP network, comprising:
receiving information from the device about the source network and about the target network;
monitoring the information received from the device to determine whether parameters of the source network have crossed a handoff threshold;
monitoring the information received from the device to determine whether parameters of the target network are suitable for handoff; and
instructing the device to perform a handover of communications to a radio associated with the target network based on the parameters of the source network, the parameters of the target network, and a handoff policy.

13. The method of claim 12, wherein the source network is the WiMAX network and the target network is the 3GPP network.

14. The method of claim 12, wherein the source network is the 3GPP network and the target network is the WiMAX network.
